(19) United States
(12) Patent Application Publication
(10) Pub. No.: US 2014/0316974 A1
(43) Pub. Date: Oct. 23, 2014

(54) System and Method for Coupling Projected and Actual Energy Cost Savings to Amortized Loans

(71) Applicants: Woodrow W. Clark, II, Beverly Hills, CA (US); Wendell Brown, Henderson, NV (US)

(72) Inventors: Woodrow W. Clark, II, Beverly Hills, CA (US); Wendell Brown, Henderson, NV (US)

(21) Appl. No.: 14/209,555

(22) Filed: Mar. 13, 2014

Related U.S. Application Data
(60) Provisional application No. 61/794,673, filed on Mar. 15, 2013.

(51) Int. Cl. G06Q 40/02

(52) U.S. Cl. CPC G06Q 40/025
USPC 705/38

(57) ABSTRACT

A computer-implemented method for computing an amortization period for a term loan is presented. The method includes computing a first amortization period such that a first payment is a first predetermined percentage of a first cost savings.

### CROSS-REFERENCES TO RELATED APPLICATIONS

This application claims priority, under 35 U.S.C. §119(e), from U.S. Provisional Application No. 61/794,673, filed on Mar. 15, 2013, entitled “SYSTEM AND METHOD FOR COUPLING PROJECTED AND ACTUAL ENERGY COST SAVINGS TO AMORTIZED LOANS”, the contents of all of which is incorporated herein by reference in its entirety.

### BACKGROUND

The present invention relates to a system and method for computing an amortization period, and more particularly, for computing an amortization period for a term loan coupled with predicted and actual energy cost savings.

Energy efficiency, conservation and onsite renewable power generation systems are important in order to achieve regional, national and international goals for the reduction of greenhouse gas emissions, fossil fuel usage, grid load strain, costs, and a wide range of other benefits to buildings ranging from homes to office buildings and complexes. However, many approaches to energy efficiency, conservation and onsite renewable power involve significant capital outlays over long periods of times as leases or add-on costs that hence create financial management risks, provide undetermined return-on-investment rates and payback periods, which may hinder the adoption of energy conserving property improvements. A significant factor may be the loan to value (LTV) ratio.

Mortgage and equity loan applicants may often be asked if they have enough equity built up in their property. For example, if the loan applicant has a property they had previously purchased for $500K, and borrowed the maximum LTV of 80% against it, i.e. $400K, then they may have built up lendable equity in the property by either paying down the initial mortgage or experiencing property appreciation. Two problems in the current economic environment may be that lenders may have reduced maximum LTVs on loans to 75% or lower, thus reducing the degree of lendable equity, and there may be no recent property appreciation. Therefore, owners that may have equity are ones that have owned their buildings for several years or more. There may be many such owners who would benefit from a mortgage financing mechanism that provides the proper evaluation for their property.

Accordingly, there is a need to provide a mortgage financing mechanism that provides the proper evaluation for an owner's property to facilitate financing energy conservation improvements.

### BRIEF SUMMARY

According to one embodiment of the present invention, a computer-implemented method for computing an amortization period for a term loan is presented. The method includes computing a first amortization period such that a first payment is a first predetermined percentage of a first cost savings.

According to one embodiment, the computer-implemented method further includes estimating the first cost savings in accordance with at least one historical energy bill. According to one embodiment, the computer-implemented method further includes estimating the first cost savings in accordance with an installation of an equipment. The equipment improves an energy efficiency.

According to one embodiment, the first amortization period includes a multitude of months. According to one embodiment, computing the first amortization period is in accordance with a maximum or a minimum amortization period. According to one embodiment, the first amortization period is electronically coupled to a financial security level.

According to one embodiment, the first payment is electronically coupled to a financial account for payment. According to one embodiment, the term loan is for a new purchase of a property. According to one embodiment, the term loan is for refinancing an existing loan on a property. According to one embodiment, the first cost savings is an estimated energy cost savings.

According to one embodiment, the computer-implemented method further includes estimating the first cost savings in accordance with an energy audit. According to one embodiment, the energy audit uses a wireless computing device.

According to one embodiment, at least one data associated with the first cost savings is electronically coupled to the computer. According to one embodiment, at least one data associated with the first cost savings is electronically collected by a smart meter. According to one embodiment, the first cost savings is electronically coupled to a financial account.

According to one embodiment, the first cost savings is used to modify a structure of the term loan. According to one embodiment, the structure of the term loan includes a value of an equity in a property, the method further includes identifying an increase in the value of the equity. According to one embodiment, the structure of the term loan includes a loan to value (LTV) ratio in a property, the method further includes identifying an increase in the loan to value (LTV) ratio.

According to one embodiment, the computer-implemented method further includes re-computing a second amortization period such that a second payment is a second predetermined percentage of a second cost savings. According to one embodiment, the computer-implemented method further includes re-computing the second amortization period after waiting for a predetermined period.

According to one embodiment, the computer-implemented method further includes re-computing a third amortization period such that a third payment is a third predetermined percentage of a third cost savings when the term loan is not paid off after re-computing the second amortization period. According to one embodiment, the second cost savings is an energy cost savings from an installation of an equipment. The equipment improves an energy efficiency.

According to one embodiment, the second cost savings is an energy cost savings during a time between computing the first amortization period and re-computing the second amortization period. According to one embodiment, the computer-implemented method further includes estimating the second cost savings.

According to one embodiment, the first and second payments are associated with a first energy-saving equipment installation. The second cost savings is an estimated energy cost savings from a second energy-saving equipment installation different than the first energy-saving equipment installation and having an energy characteristic substantially equal to the energy characteristic of the first energy-saving equipment installation.

According to one embodiment of the present invention, a non-transitory computer-readable storage medium includes instructions which when executed by a computer cause the computer to compute a first amortization period such that a first payment is a first predetermined percentage of a first cost savings.

According to one embodiment, the non-transitory computer-readable storage medium further causes the computer to estimate the first cost savings in accordance with at least one historical energy bill. According to one embodiment, the non-transitory computer-readable storage medium further causes the computer to estimate the first cost savings in accordance with an installation of an equipment adapted to improve an energy efficiency.

According to one embodiment, the non-transitory computer-readable storage medium further causes the computer to estimate the first cost savings in accordance with an energy audit. According to one embodiment, the non-transitory computer-readable storage medium further causes the computer to re-compute a second amortization period such that a second payment is a second predetermined percentage of a second cost savings. According to one embodiment, the non-transitory computer-readable storage medium further causes the computer to re-compute the second amortization period after waiting for a predetermined period.

According to one embodiment, the non-transitory computer-readable storage medium further causes the computer to re-compute a third amortization period such that a third payment is a third predetermined percentage of a third cost savings when the term loan is not paid off after re-computing the second amortization period. According to one embodiment, the non-transitory computer-readable storage medium further causes the computer to estimate the second cost savings.

According to one embodiment of the present invention, a system for computing an amortization period for a term loan is presented. The system is configured to compute a first amortization period such that a first payment is a first predetermined percentage of a first cost savings.

According to one embodiment, the system is further configured to estimate the first cost savings in accordance with at least one historical energy bill. According to one embodiment, the system is further configured to estimate the first cost savings in accordance with an installation of an equipment adapted to improve an energy efficiency. According to one embodiment, the system is further configured to estimate the first cost savings in accordance with an energy audit.

According to one embodiment, the system is further configured to re-compute a second amortization period such that a second payment is a second predetermined percentage of a second cost savings. According to one embodiment, the system is further configured to re-compute the second amortization period after waiting for a predetermined period.

According to one embodiment, the system is further configured to re-compute a third amortization period such that a third payment is a third predetermined percentage of a third cost savings when the term loan is not paid off after re-computing the second amortization period. According to one embodiment, the system is further configured to estimate the second cost savings.

A better understanding of the nature and advantages of the embodiments of the present invention may be gained with reference to the following detailed description and the accompanying drawings.

### BRIEF DESCRIPTION OF THE DRAWINGS

FIGS. 1A through FIGS. 1D depict a simplified exemplary block diagram of a networked smart energy system that may provide data electronically to an automated term loan amortization calculator, in accordance with one embodiment of the present invention.

FIG. 1A depicts a simplified exemplary block diagram of a property, in accordance with one embodiment of the present invention.

FIG. 1B depicts a simplified exemplary block diagram of a property similar to the property depicted in FIG. 1A including a smart utility meter, in accordance with one embodiment of the present invention.

FIG. 1C depicts a simplified exemplary block diagram of a wireless computing device associated with an energy use of the property depicted in FIG. 1A or FIG. 1A, in accordance with one embodiment of the present invention.

FIG. 1D depicts a simplified block diagram of a world-wide-web or cloud network linked to the smart utility meter depicted in FIG. 1B and/or to wearable-computing device depicted in FIG. 1C, in accordance with one embodiment of the present invention.

FIG. 2 depicts a simplified exemplary flowchart for computing an amortization period for a term loan coupled with predicted and actual energy cost savings, in accordance with one embodiment of the present invention.

FIG. 3 is a block diagram of a computer system that may incorporate embodiments of the present invention.

### DETAILED DESCRIPTION

Embodiments of the present invention relate particularly to energy saving methods and design of software and systems which run in computing environments such as computer hardware, virtual CPU environments, servers, computers, tablets, wireless mobile devices, and the like, that couple and integrate amortized payment terms and amounts with predicted and actual energy cost savings. Some embodiments are integrated into what may be referred to as a “networked smart energy system.” Other embodiments may provide software that may link energy efficiency, conservation and renewable energy with each other for monitoring, reducing and evaluating energy conserving improvements.

Embodiments of the present invention provide a mechanism for financial risk reduction/management and predictable cost outlays including loan repayment terms that are directly linked to energy savings, thus serving as an enabler for the financing of such energy efficiency and conservation projects. Net operating income (NOI) results may be made more accurate as a result of embodiments of the present invention to help reduce pollution, greenhouse gases and particulates. When the NOI is divided by the purchase price for a building or home including effects of energy conserving improvements, then the capitalization (CAP) rate for that property will desireably increase over a short period of time, i.e. five years or more.

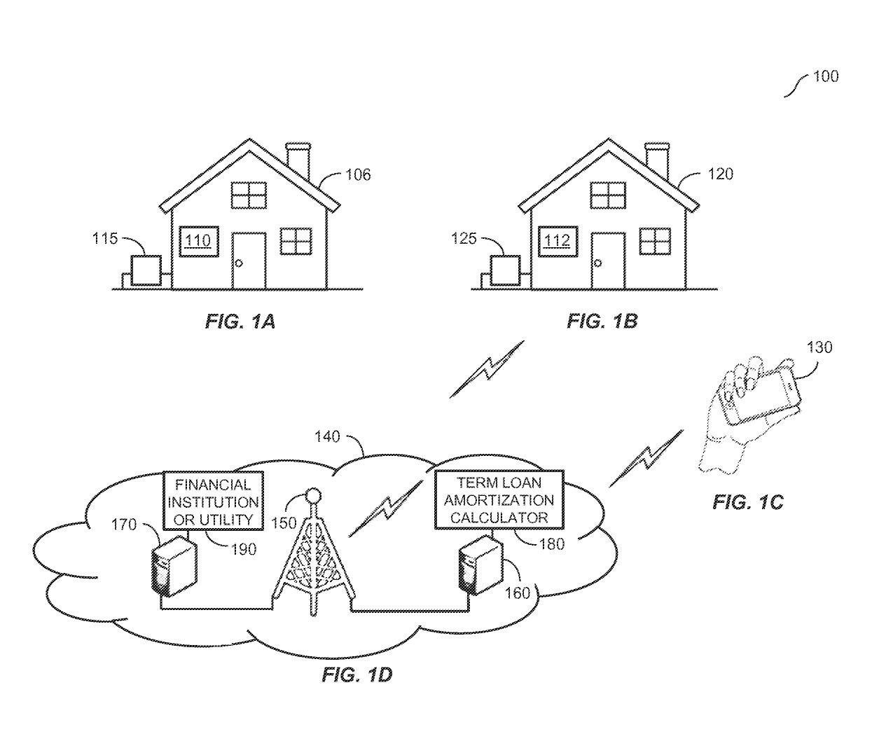

FIGS. 1A through FIGS. 1D depict a simplified exemplary block diagram of a networked smart energy system 100 that may provide data electronically to an automated term-loan amortization calculator 103, in accordance with one embodiment of the present invention. FIG. 1A depicts a simplified exemplary block diagram of a property 106, in accordance with one embodiment of the present invention. Property 106 may include an equipment installation 110 and an energy meter 115 used by an energy utility to determine actual energy use and cost by property 106 and equipment installation 110. In one embodiment, property 106 may include a building such as a home, single-family home, office building, and/or complex. Property 106 may further include a multitude of homes, single-family homes, apartments, or condominiums in one location respectively. For example, in one embodiment, the multitude of properties may be located in the same postal zip code, town, subdivision, block, property parcel, and the like.

Equipment installation 110 will improve an energy efficiency of property 106. In other words, an energy amount and associated cost, such as measured by energy meter 115, may be reduced by equipment installation 110. In one embodiment, equipment installation 110 may include replacing or retrofitting old equipment of similar function with newer energy saving equipment. For one example, equipment installation 110 may include an old energy inefficient water heater with a more energy efficient new water heater. For another example, equipment installation 110 may include replacing ten energy inefficient light bulbs by more efficient lights, such as light emitting diodes (LEDs), which provides a certain energy cost savings level over a period of time. In one embodiment, equipment installation 110 may include adding new equipment such as a solar electric panel, insulation, electronics, cooling and/or the like, that may improve the energy efficiency of property 106. In one embodiment, equipment installation 110 and/or property 106 may be financed by a term loan.

FIG. 1B depicts a simplified exemplary block diagram of a property 120 similar to property 106 depicted in FIG. 1A including a smart utility meter 125, in accordance with one embodiment of the present invention. Smart utility meter 125 or may include wired or wireless electronic communications adapted to provide electronic data transfer of energy usage of property 120 from smart utility meter 125 to a data receiver such as an energy utility, world wide web (internet), and/or wireless computing device without the need for manual data collection, in contrast to energy meter 115. Smart utility meter 125 may communicate via direct communication to the data receiver or via a grid of other smart utility meters used as intermediary communication relays to the data receiver. Smart utility meter 125 may be a “smart onsite grid” meter.

Property 120 may include energy-saving equipment installation 112 different than energy-saving equipment installation 110 in large part only because of being located in a different property than energy-saving equipment installation 110 but otherwise energy-saving equipment installation 112 may have an energy use characteristic substantially equal to the energy use characteristic of energy-saving equipment installation 110. Further, because property 120 may be similar to property 106, such as having similar size or square footage, number of rooms, energy bill size, and/or geographic region, the energy use data from smart utility meter 125 may be used to estimate the energy cost savings due to energy-saving equipment installation 110 in real-time or nearly in real-time after installation, even though real-time data from energy meter 115 in property 106 may be unavailable. For example, energy use data from meter 115 may be collected manually once a quarter, while energy use data from smart meter 125 may be electronically collected more frequently, e.g. hourly or daily and may be electronically coupled to a computer running software embodiments of the present invention.

FIG. 1C depicts a simplified exemplary block diagram of a wireless computing device 130 associated with an energy use of property 106, 120 depicted in FIG. 1A or FIG. 1A, in accordance with one embodiment of the present invention. Wireless computing device 130 may include cellular and/or WiFi circuits that enable electronic communication between wireless computing device 130 and smart utility meter 125, equipment installation 110, and/or the internet. In one embodiment, wireless computing device 130 may be used to conduct an energy audit of property 106 and/or property 120 to help determine the energy cost savings produced over time by equipment installation 110. In another embodiment, computing device 130 may be used to run software associated with embodiments of the present invention.

FIG. 1D depicts a simplified block diagram of a world-wide-web or cloud network 140 linked to smart utility meter 125 depicted in FIG. 1B and/or to wireless computing device 130 depicted in FIG. 1C, in accordance with one embodiment of the present invention. FIG. 1D shows a base station 150 for sending or receiving cellular or WiFi® radio transmission to or from wireless computing device 130 or for data communication to or from smart utility meter 125. Base station 150 may be coupled to one or more server computing devices 160, 170. In one embodiment, a multitude of servers may be located in different locations or in multiple clouds. In one embodiment, server computing device 160 may run software associated with term loan amortization calculator 180, hereinafter also referred to as the “system”. In another embodiment, server computing device 190 may run software associated with a financial institution such as a lender of the term loan and/or an energy utility 190 that may be a third party.

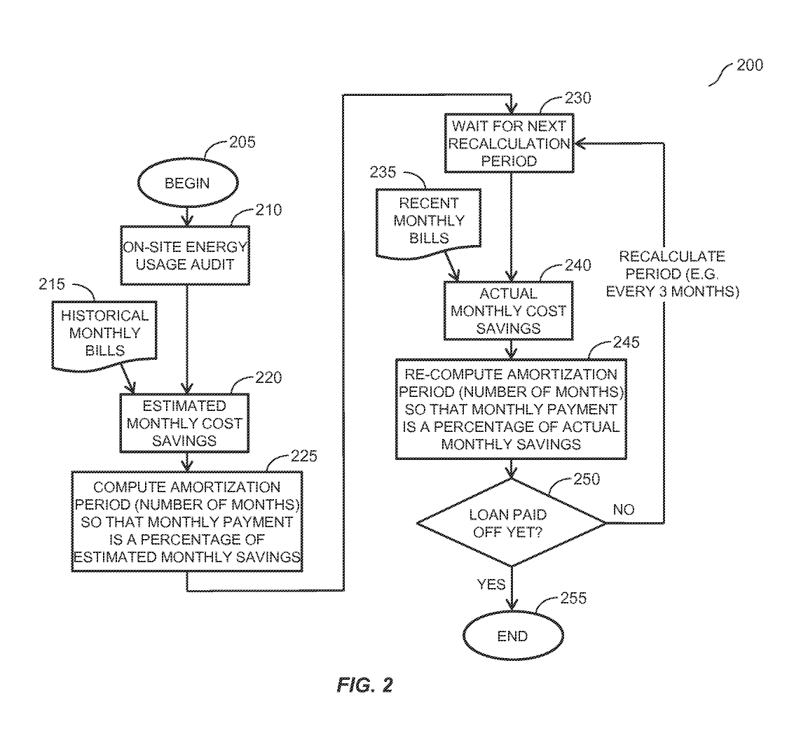

FIG. 2 depicts a simplified exemplary flowchart 200 for computing an amortization period for a term loan coupled with predicted and actual energy cost savings, in accordance with one embodiment of the present invention. Embodiments of the present invention depicted in FIG. 2 may be may incorporated and/or executed in term loan amortization calculator 180 depicted in FIG. 1D. Referring simultaneously to FIGS. 1A through FIGS. 1D and FIG. 2, in one embodiment after beginning 205, flowchart 200 may include estimating 220 an energy cost savings due to future or suggested equipment installation 110, 125 in accordance with inputs such as conducting an on-site energy audit 210, using at least one historical actual monthly energy usage cost or bill 215, and/or the estimated energy cost savings of the suggested equipment installation 110, 125. In one embodiment, the energy audit may be manually or automatically estimated.

Next, flowchart 200 further includes computing 225 an initial amortization period, i.e. the total number of months needed to pay off the term loan, such that an initial monthly or other periodic payment is a predetermined percentage, such as for example 50%, of the estimated energy cost savings of the future equipment installation 110, 125. After equipment installation 110, 125 the flowchart 200 further includes waiting 230 for a predetermined period of time, i.e. a recalculation period, such as for example three months while at least one recent monthly energy usage cost or bill 235 is used to determine actual monthly cost savings data 240, which in turn is used to re-compute 245 a new amortization period, e.g. 12 months, such that a new monthly loan payment is a new predetermined percentage of an actual cost savings due to equipment installation 110, 125. In one embodiment, the actual cost savings is an energy cost savings during a time, i.e. the recalculation period, between computing the estimated amortization period and re-computing the actual amortization period. In one embodiment, the new predetermined percentage, such as for example 50%, may equal the initial predetermined percentage. In one embodiment, the energy usage data or energy cost savings may be seasonally adjusted.

In one embodiment, if the loan is not paid off 250 yet in full after re-computing the actual amortization, flowchart 200 further includes repeating re-computing the amortization period using the actual monthly cost savings collected during the recalculation period, i.e. every three months. For example, the next re-computed amortization period may be 10 months to pay down the loan based on the newly collected data. The re-computation of the amortization period based on energy data usage/cost savings every recalculation period may be repeated until the loan is paid off 250, which ends 255 the flow.

In one embodiment, computing the initial amortization period or re-computing the actual amortization period is in accordance with a maximum amortization period, such as for example 60 months. In one embodiment, computing the initial amortization period or re-computing the actual amortization period is in accordance with a minimum amortization period.

In one embodiment, the re-computed amortization period may be done according to estimated energy cost savings. For example, the re-computed amortization period for a term loan on energy-saving equipment installation 110 may be estimated using actual cost savings from property 120 with energy-saving equipment installation 112 including an energy use characteristic substantially equal to the energy use characteristic of energy-saving equipment installation 110 as discussed above in reference to FIG. 1B.

Referring simultaneously to FIGS. 1A through FIGS. 1D and FIG. 2, in one embodiment, at least one data associated with the estimated or actual energy cost savings may be electronically coupled to the computer or server running term loan amortization calculator 180 via smart meter 125 as a direct, automated data input, such as via automated collection of monthly energy bills for a customer's property. In another embodiment, the initial payment or the re-computed payment generated when a new amortization period is re-computed 245 may be electronically coupled to an account at financial institution 190 for payment. In one embodiment, the financial account may be the financial institution collecting the loan payments, such as via a bank account, credit card, debit card, automated clearinghouse (ACH) and/or the like. For example, EDI electronic data interchange (EDI), internet communications, HTTP, HTTPS and/or similar internet data exchange protocols may be used to electronically couple the data to amortization calculator 180 and/or financial institution 190.

In another embodiment, the initial payment or the re-computed payment may be electronically transmitted or coupled to a 3rd party automatically, such as an electric utility bill, existing monthly mortgage payment, and/or other monthly payments. Therefore, the system allows, for example, an energy utility company the ability to collect a single combined total amount including the underlying monthly energy bill and the computed monthly loan payment amount.

In another embodiment, the financial institution collecting the loan payments may be a third party collection system such as Paypal, or the like. In one embodiment, the initial monthly payment or the re-computed monthly payments may be electronically debited automatically to the financial account.

In one embodiment, the initial monthly payment or the re-computed monthly payments may be continually revised monthly payments. In one embodiment, the payment period and/or the recalculation period may not be limited to monthly periods but may be any fixed period type.

For example, a payment period may be weekly, daily, quarterly, and the like. In another embodiment, the payment period and/or the recalculation period may not be limited to a fixed period such that the period type may change over time. For example, the first six months may be monthly payment period and the next six months may be quarterly payment periods.

In one embodiment, energy savings from one equipment installation 110 or 112 may be extrapolated or predicted and applied to re-compute 245 a new amortization period during a future recalculation period. For example, the cost savings from replacing 10 low energy efficiency light bulbs with 10 light emitting diode (LED) high efficiency lights during a first recalculation period produce a certain savings level. That savings level may be extrapolated to the next recalculation period when an additional number of low energy efficiency light bulbs are replaced with the LED lights. Thus, the energy cost savings from equipment installation 110, 112 may be applied to staged installation projects within sequential recalculation periods.

In one embodiment, the initial energy cost savings or the actual energy cost savings may be electronically coupled to a financial account. For example, the financial account may be with the lender and the energy cost savings information may be used to modify the loan structure, such as increase the property value due to equipment installation 110, 112, adjust LTV, incorporate the energy cost savings in the loan underwriting. For example, when a borrower is borrowing as much as they can initially pay, lenders may apply what is called debt service coverage, then a lender may not lend the borrower anymore. A lender may allow for cash flow savings in their underwriting calculations due to prospective lower energy costs. Usually, lenders are reluctant to apply prospective cash flow savings in underwriting calculations, especially in this environment when many of the loan losses were due to pro forma cash flow predictions that never were realized. Engineering or service companies that may provide the energy savings through incentives such as to arrange some of the energy saving equipment installation 110, 112 retrofits, profit tax breaks and some initial funding. In this case, there may be flexibility. The lender may in some cases receive the incentives directly for the mortgage, which could be passed on to the client or used in another manner.

In one embodiment, the structure of the term loan includes a value of an equity in property 106, 120 and the system may identify an increase in the value of the equity. For example, the networked smart energy system 100 and term-loan amortization calculator 180 may identify or target loans to properties where owners have built up equity via energy saving equipment installation 110, 112. In the commercial space, this may represent a meaningful portion of the stock of small commercial properties. In one embodiment, the system identifies properties and lenders willing to provide 2nd liens (equity loans or lines) for the purpose of doing property improvements such as energy projects on properties with lendable equity to tap. The energy savings project may thus be financed through a mortgage.

In one embodiment, the structure of the term loan includes a value of an equity in property 106, 120 and the system may identify an increase in the loan to value (LTV) ratio. For example, to minimize their down payment, if a buyer wants an 80% loan on their $500K property to minimize their down payment such that the down payment is $100K of personal down payment. The lender may already be at the maximum LTV yet a $50K equipment installation retrofit is desired to save energy. The system may provide the way to evaluate the property as being worth $550K ahead of the retrofit project being completed.

In one embodiment, the first amortization period or the second amortization period is electronically may be coupled to a financial security level associated with property 105, 120. For example, the system may couple changes effecting an underlying financial security agreement, such as for example, a California uniform commercial code (UCC)-1 filing, in which the system periodically updates that financial security level based on the updated loan balance level. In one embodiment, the term loan may be for refinancing an existing loan on property 105, 120. In another embodiment, the term loan may be for refinancing an existing loan on property 105, 120.

In one embodiment, multiple homes in a single location such as apartments or condominiums are distinguished from single family homes in that net operating income (NOI) may be used for establishing the multiple home complex value. The NOI may be established after gross costs are taken out of the home value. The capitalization (Cap) rate may be calculated monthly over a year and is the NOI divided by the purchase price of the property.

In one embodiment, single family home value may be based on supply and demand in the geographic area, such as for example within 8-10 square blocks, of the home for sale. The price may be dependent upon the Caps, e.g. selling prices, of homes sold in the last 6 months in the surrounding area of similar square footage, number of rooms, and the like. There may be a price per square foot that may be used to establish the value of the home. Cap rate foe a single family home may be the NOI divided by the Purchase Price but with nothing under 6% rate since that does not make it profitable enough for the seller and their agents.

In one embodiment, formulas for computing 225 an initial amortization period and to re-compute 245 a new amortization period may be as follows and are understood to generate not only the amortization period but also the amortization parameters described below. The formula for the periodic payment amount A may be derived as follows. For an amortization schedule, a function p(t) may be defined that represents the principal amount remaining at time t. One may then derive a formula for p(t) given an unknown payment amount A and r=1+i, where i is the periodic interest rate.

p(0)=P

p(1)=p(0)r−A=Pr−A

p(2)=p(1)r−A=Pr²−Ar−A

p(3)=p(2)r−A=Pr³−Ar²−Ar−A

p(t)=Pr^{t}−AΣₖ₌₀^{t-1}r^{k}.

Applying the substitution,

Σₖ₌₀^{t-1}r^{k}−1+r+r² . . . +r^{t-1}=(r^{t}−1/(r−1)

to p(t) above and simplification gives

p(t)/P=1−[(1+i)^{t}−1]/[(1+i)ⁿ−1],

where n is the number of payment periods. The resulting annuity formula for periodic payment amount A is given by

A=P×[i(1+i)ⁿ]/[(1+i)ⁿ−1]=(P×i)/[1−(1+i)⁻ⁿ]=P×{i+[i/[(1+i)ⁿ−1]]}.

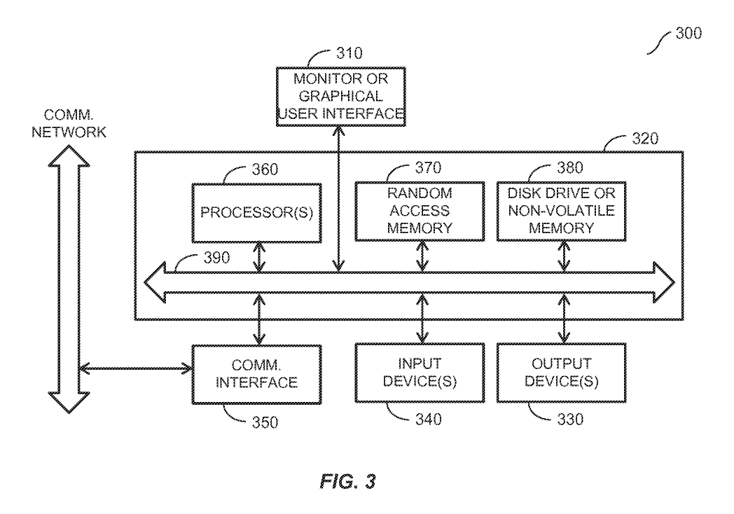

FIG. 3 is a block diagram of a computer system that may incorporate embodiments of the present invention. FIG. 3 is merely illustrative of an embodiment incorporating the present invention and does not limit the scope of the invention as recited in the claims. One of ordinary skill in the art would recognize other variations, modifications, and alternatives.

In one embodiment, computer system 300 typically includes a monitor 310, a computer 320, user output devices 330, user input devices 340, communications interface 350, and the like.

As shown in FIG. 3, computer 320 may include a processor(s) 360 that communicates with a number of peripheral devices via a bus subsystem 390. These peripheral devices may include user output devices 330, user input devices 340, communications interface 350, and a storage subsystem, such as random access memory (RAM) 370 and disk drive 380.

User input devices 330 include all possible types of devices and mechanisms for inputting information to computer system 320. These may include a keyboard, a keypad, a touch screen incorporated into the display, audio input devices such as voice recognition systems, microphones, and other types of input devices. In various embodiments, user input devices 330 are typically embodied as a computer mouse, a trackball, a track pad, a joystick, wireless remote, drawing tablet, voice command system, eye tracking system, and the like. User input devices 330 typically allow a user to select objects, icons, text and the like that appear on the monitor 310 via a command such as a click of a button or the like.

User output devices 340 include all possible types of devices and mechanisms for outputting information from computer 320. These may include a display (e.g., monitor 310), non-visual displays such as audio output devices, etc.

Communications interface 350 provides an interface to other communication networks and devices. Communications interface 350 may serve as an interface for receiving data from and transmitting data to other systems. Embodiments of communications interface 350 typically include an Ethernet card, a modem (telephone, satellite, cable, ISDN), (asynchronous) digital subscriber line (DSL) unit, FireWire interface, USB interface, and the like. For example, communications interface 350 may be coupled to a computer network, to a FireWire bus, or the like. In other embodiments, communications interfaces 350 may be physically integrated on the motherboard of computer 320, and may be a software program, such as soft DSL, or the like.

In various embodiments, computer system 300 may also include software that enables communications over a network such as the HTTP, TCP/IP, RTP/RTSP protocols, and the like. In alternative embodiments of the present invention, other communications software and transfer protocols may also be used, for example IPX, UDP or the like.

In some embodiment, computer 320 includes one or more Xeon microprocessors from Intel as processor(s) 360. Further, one embodiment, computer 320 includes a UNIX-based operating system.

RAM 370 and disk drive 380 are examples of tangible media configured to store data such as embodiments of the present invention, including executable computer code, human readable code, or the like. Other types of tangible media include floppy disks, removable hard disks, optical storage media such as CD-ROMS, DVDs and bar codes, semiconductor memories such as flash memories, non-transitory read-only-memories (ROMS), battery-backed volatile memories, networked storage devices, and the like. RAM 370 and disk drive 380 may be configured to store the basic programming and data constructs that provide the functionality of the present invention.

Software code modules and instructions that provide the functionality of the present invention may be stored in RAM 370 and disk drive 380. These software modules may be executed by processor(s) 360. RAM 370 and disk drive 380 may also provide a repository for storing data used in accordance with the present invention.

RAM 370 and disk drive 380 may include a number of memories including a main random access memory (RAM) for storage of instructions and data during program execution and a read only memory (ROM) in which fixed non-transitory instructions are stored. RAM 370 and disk drive 380 may include a file storage subsystem providing persistent (non-volatile) storage for program and data files. RAM 370 and disk drive 380 may also include removable storage systems, such as removable flash memory.

Bus subsystem 390 provides a mechanism for letting the various components and subsystems of computer 320 communicate with each other as intended. Although bus subsystem 390 is shown schematically as a single bus, alternative embodiments of the bus subsystem may utilize multiple busses.

FIG. 3 is representative of a computer system capable of embodying the present invention. It will be readily apparent to one of ordinary skill in the art that many other hardware and software configurations are suitable for use with the present invention. For example, the computer may be a desktop, portable, rack-mounted or tablet configuration. Additionally, the computer may be a series of networked computers. Further, the use of other microprocessors are contemplated, such as Pentium™ or Itanium™ microprocessors; Opteron™ or AthlonXP™ microprocessors from Advanced Micro Devices, Inc; and the like. Further, other types of operating systems are contemplated, such as Windows®, WindowsXP®, WindowsNT®, or the like from Microsoft Corporation, Solaris from Sun Microsystems, LINUX, UNIX, and the like. In still other embodiments, the techniques described above may be implemented upon a chip or an auxiliary processing board.

Various embodiments of the present invention can be implemented in the form of logic in software or hardware or a combination of both. The logic may be stored in a computer readable or machine-readable non-transitory storage medium as a set of instructions adapted to direct a processor of a computer system to perform a set of steps disclosed in embodiments of the present invention. The logic may form part of a computer program product adapted to direct an information-processing device to perform a set of steps disclosed in embodiments of the present invention. Based on the disclosure and teachings provided herein, a person of ordinary skill in the art will appreciate other ways and/or methods to implement the present invention.

The data structures and code described herein may be partially or fully stored on a computer-readable storage medium and/or a hardware module and/or hardware apparatus. A computer-readable storage medium includes, but is not limited to, volatile memory, non-volatile memory, magnetic and optical storage devices such as disk drives, magnetic tape, CDs (compact discs), DVDs (digital versatile discs or digital video discs), or other media, now known or later developed, that are capable of storing code and/or data. Hardware modules or apparatuses described herein include, but are not limited to, application-specific integrated circuits (ASICs), field-programmable gate arrays (FPGAs), dedicated or shared processors, and/or other hardware modules or apparatuses now known or later developed.

The methods and processes described herein may be partially or fully embodied as code and/or data stored in a computer-readable storage medium or device, so that when a computer system reads and executes the code and/or data, the computer system performs the associated methods and processes. The methods and processes may also be partially or fully embodied in hardware modules or apparatuses, so that when the hardware modules or apparatuses are activated, they perform the associated methods and processes. The methods and processes disclosed herein may be embodied using a combination of code, data, and hardware modules or apparatuses.

The above embodiments of the present invention are illustrative and not limiting. Various alternatives and equivalents are possible. Although, the invention has been described with reference to energy cost saving by way of an example, it is understood that the invention is not limited by the type of cost saving. Although, the invention has been described with reference to installation of certain types of energy saving equipment by way of an example, it is understood that the invention is not limited by the type of energy saving equipment installed. Although, the invention has been described with reference to monthly loan payment periods by way of an example, it is understood that the invention is not limited by the length of the loan payment period. Other additions, subtractions, or modifications are obvious in view of the present disclosure and are intended to fall within the scope of the appended claims.

What is claimed is:

1. A computer-implemented method for computing an amortization period for a term loan, the method comprising:
computing a first amortization period such that a first payment is a first predetermined percentage of a first cost savings.

2. The computer-implemented method of claim 1 further comprising estimating the first cost savings in accordance with at least one historical energy bill.

3. The computer-implemented method of claim 1 further comprising estimating the first cost savings in accordance with an installation of an equipment, wherein the equipment improves an energy efficiency.

4. The computer-implemented method of claim 1, wherein the first amortization period includes a plurality of months.

5. The computer-implemented method of claim 1, wherein computing the first amortization period is in accordance with a maximum or a minimum amortization period.

6. The computer-implemented method of claim 1, wherein the first amortization period is electronically coupled to a financial security level.

7. The computer-implemented method of claim 1, wherein the first payment is electronically coupled to a financial account for payment.

8. The computer-implemented method of claim 1, wherein the term loan is for a new purchase of a property.

9. The computer-implemented method of claim 1, wherein the term loan is for refinancing an existing loan on a property.

10. The computer-implemented method of claim 1, wherein the first cost savings is an estimated energy cost savings.

11. The computer-implemented method of claim 1 further comprising estimating the first cost savings in accordance with an energy audit.

12. The computer-implemented method of claim 11, wherein the energy audit uses a wireless computing device.

13. The computer-implemented method of claim 1, wherein at least one data associated with the first cost savings is electronically coupled to the computer.

14. The computer-implemented method of claim 13, wherein at least one data associated with the first cost savings is electronically collected by a smart meter.

15. The computer-implemented method of claim 1, wherein the first cost savings is electronically coupled to a financial account.

16. The computer-implemented method of claim 15, wherein the first cost savings is used to modify a structure of the term loan.

17. The computer-implemented method of claim 16, wherein the structure of the term loan includes a value of an equity in a property, the method further comprising identifying an increase in the value of the equity.

18. The computer-implemented method of claim 16, wherein the structure of the term loan includes a loan to value (LTV) ratio in a property, the method further comprising identifying an increase in the loan to value (LTV) ratio.

19. The computer-implemented method of claim 1 further comprising re-computing a second amortization period such that a second payment is a second predetermined percentage of a second cost savings.

20. The computer-implemented method of claim 19 further comprising re-computing the second amortization period after waiting for a predetermined period.

21. The computer-implemented method of claim 19 further comprising re-computing a third amortization period such that a third payment is a third predetermined percentage of a third cost savings when the term loan is not paid off after re-computing the second amortization period.

22. The computer-implemented method of claim 19, wherein the second cost savings is an energy cost savings from an installation of an equipment, wherein the equipment improves an energy efficiency.

23. The computer-implemented method of claim 19, wherein the second cost savings is an energy cost savings during a time between computing the first amortization period and re-computing the second amortization period.

24. The computer-implemented method of claim 19 further comprising estimating the second cost savings.

25. The computer-implemented method of claim 24, wherein the first and second payments are associated with a first energy-saving equipment installation, wherein the second cost savings is an estimated energy cost savings from a second energy-saving equipment installation different than the first energy-saving equipment installation and having an energy characteristic substantially equal to the energy characteristic of the first energy-saving equipment installation.

26. A non-transitory computer-readable storage medium comprising instructions which when executed by a computer cause the computer to:
compute a first amortization period such that a first payment is a first predetermined percentage of a first cost savings.

27. The non-transitory computer-readable storage medium of claim 26 further causing the computer to estimate the first cost savings in accordance with at least one historical energy bill.

28. The non-transitory computer-readable storage medium of claim 26 further causing the computer to estimate the first cost savings in accordance with an installation of an equipment adapted to improve an energy efficiency.

29. The non-transitory computer-readable storage medium of claim 26 further causing the computer to estimate the first cost savings in accordance with an energy audit.

30. The non-transitory computer-readable storage medium of claim 26 further causing the computer to re-compute a second amortization period such that a second payment is a second predetermined percentage of a second cost savings.

31. The non-transitory computer-readable storage medium of claim 30 further causing the computer to re-compute the second amortization period after waiting for a predetermined period.

32. The non-transitory computer-readable storage medium of claim 30 further causing the computer to re-compute a third amortization period such that a third payment is a third predetermined percentage of a third cost savings when the term loan is not paid off after re-computing the second amortization period.

33. The non-transitory computer-readable storage medium of claim 30 further causing the computer to estimate the second cost savings.

34. A system for computing an amortization period for a term loan, the system configured to:
compute a first amortization period such that a first payment is a first predetermined percentage of a first cost savings.

35. The system of claim 34 further configured to estimate the first cost savings in accordance with at least one historical energy bill.

36. The system of claim 34 further configured to estimate the first cost savings in accordance with an installation of an equipment adapted to improve an energy efficiency.

37. The system of claim 34 further configured to estimate the first cost savings in accordance with an energy audit.

38. The system of claim 34 further configured to re-compute a second amortization period such that a second payment is a second predetermined percentage of a second cost savings.

39. The system of claim 38 further configured to re-compute the second amortization period after waiting for a predetermined period.

40. The system of claim 38 further configured to re-compute a third amortization period such that a third payment is a third predetermined percentage of a third cost savings when the term loan is not paid off after re-computing the second amortization period.

41. The system of claim 38 further configured to estimate the second cost savings.
